(19) United States
(12) Patent Application Publication
(10) Pub. No.: US 2008/0067704 A1
(43) Pub. Date: Mar. 20, 2008

(54) Micro-Molding Equipment and Micro-Molding Method

(75) Inventors: Hitoshi Ohmori, Saitama (JP); Yoshihiro Uehara, Saitama (JP); Weimin Lin, Saitama (JP); Hatsuichi Takeyasu, Tokyo (JP); Masao Washio, Saitama (JP); Keizo Ikegami, Saitama (JP); Takeya Shoji, Saitama (JP); Tomoaki Ando, Saitama (JP); Yukihiro Shirataki, Saitama (JP)

Correspondence Address: GRIFFIN & SZIPL, PC, SUITE PH-1, 2300 NINTH STREET, SOUTH, ARLINGTON, VA, 22204, US

(73) Assignees: RIKEN, Saitama (JP); THE NEXSYS CORPORATION, Tokyo (JP); SAN SEIMITSU KAKO LAB., LTD., Saitama (JP); IKEGAMI MOLD ENGINEERING CO., LTD., Saitama (JP); ASTOM R&D, Saitama (JP)

(21) Appl. No.: 11/577,214

(22) PCT Filed: Oct. 18, 2005
(86) PCT No.: PCT/JP05/19100

§ 371 Date: Apr. 13, 2007

(30) Foreign Application Priority Data
Oct. 18, 2004 (JP) 2004-302356

(51) Int. Cl. B29C 43/18

(52) U.S. Cl. 264/2.4; 425/509

(57) ABSTRACT

The micro-molding equipment contains a preform molding equipment 10 taking a single-cavity of a preform material 3 corresponding to a small precision optical component to be molded with a runnerless mold, and a precision compression molding equipment 40 for after molding the preform material 3 by primary compression molding in a vacuum state, cooling the preform material to a temperature near a glass transition point, and then re-softening a surface layer of the preform material and molding the same by secondary compression molding to transfer the small precision optical component thereto.

### BACKGROUND OF THE INVENTION

1. Technical Field of the Invention

The present invention relates to a micro-molding equipment and a micro-molding method capable of mass-producing optical components having a shape of uneven thickness and thick wall by fine and precise shape transfer without loss of material.

2. Description of the Related Art

A molding means for producing a precision optical component such as a lens or the like by molding a preform material by injection molding and further molding the same by means of compression molding to transfer a fine and precise shape to the molded material has been conventionally known.

However, conventionally, since a plurality of preform materials are simultaneously molded by injection molding or the like, a part (referred to as a runner part) for supplying melted materials (raw materials) to each of the preform materials is integrally molded with the preform materials and thereby there has been a problem that it becomes necessary to scrap or recycle a large amount of materials corresponding to the runner part.

Consequently, there is provided, in part, a proposal of means for injection molding without a runner part in order to prevent such loss of materials (refer to Japanese Patent Application Laid-Open (Kokai) No. Hei6-339954 “Runnerless Mold” (patent document 1) and Japanese Patent Application Laid-Open (Kokai) No. Hei8-103929 “Spur Injection Mold” (patent document 2)).

There is also provided, in part, a proposal of means for manufacturing a precision optical component such as a lens by molding a preform material between molds by way of compression molding for (refer to Japanese Patent Application Laid-Open (Kokai) No. 2002-114524 “Lens Manufacturing Apparatus and Lens Manufacturing Method” (patent document 3)).

As illustrated in FIG. 1, the “Runnerless Mold” according to patent document 1 includes a manifold 51 for holding the injected molding material in sprues 54 and a runner 55 in a melting state and cavities 57 for molding molded items, and is characterized in that the capacity of the molding material accumulated in the manifold is equal to or less than ⅔ of full capacity of the cavity.

With this configuration, all of the molding materials in the manifold are renewed for every shot, and this enables to easily perform continuous molding and to prevent most of defective molding.

The “Spur Injection Mold” according to patent document 2 is a hot runner type of a runnerless mold for high-speed and mass production, and is configured by a double nesting structure in which a fixed block 60 contains an outer bush block 64 and a middle bush block 65 with a built-in heater 68. The middle bush block 65 is made of a stainless material with low thermal conductivity in order to insulate the heat of the heater 68, and a heat insulating space 61 is provided between the middle bush block 65 and the outer bush block 64. Also, the outer bush block 64 is made of a material with high thermal conductivity such as a copper-beryllium alloy or the like, to improve the cooling effect by cooling water holes 66 and 67.

The “lens manufacturing apparatus and lens manufacturing method” according to patent document 3 are intended to manufacture a small diameter lens with a high accuracy, and as illustrated in FIG. 3, contain a preform process for sandwiching a preform 75 made of a lens material between a pair of molds 74a and 74b, and a heat molding process for pressurizing the sandwiched preform 75 while heating the same to mold the same into a predetermined shape, and carry out the sequence of the preform process and the heat molding process under vacuum.

The capacity of fine optical components (hereinafter referred to as “small precision optical components” or simply as “small components”) made of a resin such as an optical pickup lens, a lens array, and a light guide plate for mobiles has been remarkably advancing toward small capacity, following recent tendency to miniaturization and refinement. On the contrary, however, there has been a delay in responding to such small components in injection molding apparatus, and therefore, it results in performing injection molding by an injection molding machine having a large capacity of capability of plasticizing small components, which may lead to following problems.

(1) The molding capacity for a single shot of the injection molding machine is far larger than the capacity of a small component. Therefore, “taking multiple-cavities” for molding a number of small components by a single shot is performed. As a result, the sprue part and the runner part have a high ratio in the molding capacity and a ratio of the resin to be disposed of or to be recycled becomes very high. For instance, in case of an 8 to 12 pieces-cavities mold generally-adopted, the product volume relative to total mold volume is only 1/13 to 1/9, and the amount of energy that is about 10 times as much as the amount of energy originally required is consumed resulting in much energy loss.

(2) On the contrary, injection molding means for taking a single-cavity with a runnerless mold is disclosed in patent documents 1 and 2. However, since the component is greatly deformed due to a problem of overpack caused by pressure, it is difficult to mold a finer small precision optical component.

That is, when molding a small precision optical component having uneven thickness and thick wall, the resin materials are heated at high temperature to be in a fluid state. In this case, the resin materials are expanded and gate-sealed after the resin materials are injected. Then, the resin materials are filled in the cavity, and thereafter, rapidly start to solidify from the surface layer, resulting in a significant delay in inner solidification. In this case, since the molded component having thick wall and uneven thickness has uneven contractions equivalent to the uneven thickness as well as overall contractions, it is difficult to transfer the fine shape while maintaining the contraction equal to or below the differential contractions.

(3) In addition, as described in patent document 3, lens manufacturing means for performing a preform process and a heat molding process under vacuum is disclosed. With this means, however, since it is necessary to manufacture a preform material in a separate process in advance, this results in loss of a large amount of energy. Also, since the preform material sandwiched between the molds in the heat molding process is pressurized while being heated to high temperature in order to have a predetermined shape, the whole resin materials are expanded due to heating, and thereafter the preform materials are rapidly cooled from the surface layer thereof, resulting in a significant delay in inner cooling. In this case, since the molded component having uneven thickness has uneven contractions equivalent to the uneven thickness as well as overall contractions, this results in difficulty in transferring the fine shape while maintaining the contraction equal to or below the differential contractions.

The present invention is made to solve such problems. That is, it is an object of the present invention to provide a micro-molding equipment and a micro-molding method which are capable of taking a single-cavity of a preform material with a runnerless mold without causing great inner deformation due to overpack or the like caused by pressure, and capable of transferring the fine and precise shape while avoiding uneven contract of molded components having uneven thickness and thick wall, with less energy loss.

### SUMMARY OF THE INVENTION

According to the present invention, there is provided a micro-molding equipment containing a preform molding equipment for taking a single-cavity of a preform material corresponding to a small precision optical component to be molded with a runnerless mold, and a precision compression molding equipment for cooling the preform material to a temperature near a glass transition point after performing primary compression molding of the preform material in a vacuum state, then re-softening a surface layer of the preform material for secondary compression molding to transfer the small precision optical component thereto.

According to the preferred embodiment of the present invention, the preform molding equipment contains a precise quantitation injection equipment which heats and plasticizes a resin, kneads the plasticized melted resin, and injects a predetermined amount of melted resin, and a preform molding equipment which has a separable mold for solidifying an ejected melted resin with a runnerless mold and molding the same into the preform material and which is capable of automatically ejecting the molded preform material.

In addition, the precision compression molding equipment contains a plurality of pairs of precision compression molds including cavities corresponding to small precision optical components to be molded, a mold index device for sequentially moving the plurality of pairs of precision compression molds by a predetermined amount, a vacuum device for depressurizing insides of the precision compression molds to a vacuum state, heating devices for heating the precision compression molds, compression molding devices for performing compression molding by compressing the precision compression molds, and the cooling devices for cooling the precision compression molds to temperature near a glass transition point, and the precision compression molding equipment heats the precision compression molds in the vacuum state to perform primary compression molding, then reheats the precision compression molds to soften surfaces of the small precision optical components adhering tightly to the molds by the necessity minimum of thickness, and performs secondary compression molding for transferring the fine and precise shapes.

In addition, according to the present invention, there is provided a micro-molding method including a preform molding process for taking a single-cavity of a preform material corresponding to a small precision optical component to be molded, and a precision compression molding process for cooling the preform material to a temperature near a glass transition point after molding the preform material by primary compression molding in a vacuum state, and then re-softening a surface layer of the preform material and molding the same by secondary compression molding to transfer the small precision optical component thereto.

According to the preferred embodiment of the present invention, the preform molding process contains a precise quantitation injection process for heating and plasticizing a resin, kneading the plasticized melted resin, and injecting a predetermined amount of melted resin, a preform molding process for solidifying the injected melted resin with a runnerless mold to mold into the same into the preform material, and a perform ejection process for ejecting the molded preform material.

In addition, the precision compression molding process includes a mold index process for sequentially moving a plurality of pairs of precision compression molds containing cavities corresponding to small precision optical components to be molded by a predetermined amount, a vacuum process for depressurizing insides of the precision compression molds to a vacuum state, a primary compression molding process for performing primary compression molding by heating the precision compression molds in the vacuum state, a cooling process for cooling the precision compression molds to temperature near a glass transition point, and a secondary compression molding process for reheating the precision compression molds to soften surfaces of the small precision optical components adhering tightly to the molds for the necessity minimum of thickness, and transferring fine and precise shapes thereto.

In addition, according to the preferred embodiment of the present invention, it is possible to provide an optimal condition based on simulation according to a finite element method by inputting material physical value, type structure data, type temperature, type compression conditions, or the like, when determining compression conditions of the precision compression molding process.

According to the equipment and method of the present invention, a single-cavity of a preform material corresponding to a small precision optical component to be molded is taken with a runnerless mold, and therefore, this enables to take a single-cavity of a preform material without generating any great inner deformation due to overpack or the like caused by pressure.

In addition, after primary compression molding of the preform material is performed in a vacuum state, the surface layer of the preform material is re-softened to mold the same by secondary compression molding and transfers the small precision optical component thereto. Thus, this enables to transfer fine and precise shape by avoiding uneven contractions of a molded part having uneven thickness and thick wall.

Further, since a single-cavity of the preform material is taken with a runnerless mold and the preform material is subjected to precise compression molding, this enables to greatly reduce energy loss, compared to a case in which multiple-cavities of preform materials are taken or a case in which the preform material is manufactured in a separate process.

### BRIEF DESCRIPTION OF THE DRAWINGS

FIG. 1 is a block diagram of a “runnerless mold” according to patent document 1.

FIG. 2 is a block diagram of a “spur injection mold” according to patent document 2.

FIG. 3 is a block diagram of a “lens manufacturing equipment and lens manufacturing method” according to patent document 3.

FIG. 4 is an overall block diagram of a micro-molding equipment according to the present invention.

FIG. 5 is a block diagram of a preform molding equipment in FIG. 4.

FIGS. 6A through 6D are explanatory diagrams illustrating action of the preform molding equipment in FIG. 4.

FIG. 7 is an overall perspective view of precise quantitation injection equipment in FIG. 4.

FIG. 8 is an explanatory diagram illustrating action of a micro-molding method according to the present invention.

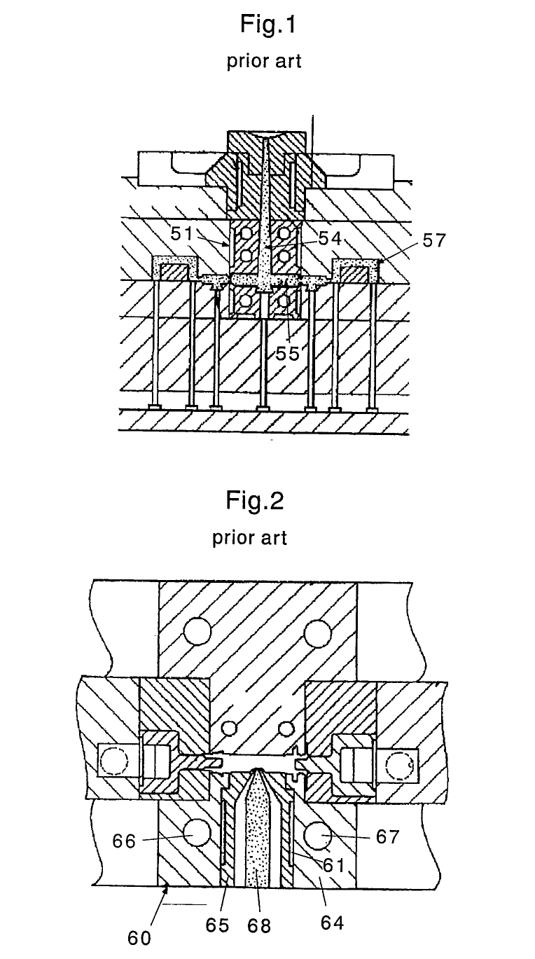

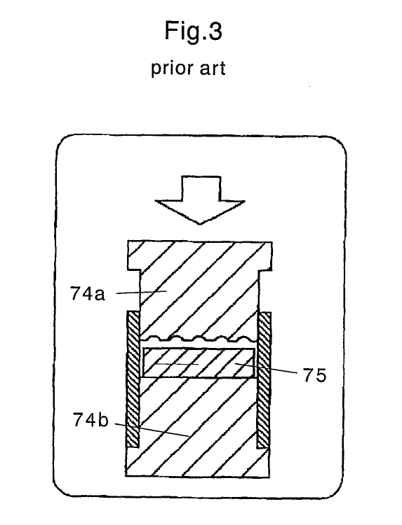

### DESCRIPTION OF THE PREFERRED EMBODIMENT

Preferred embodiments of the present invention will be described below with reference to the accompanying figures. In the figures, the same reference numerals are given to parts common to each of the drawings and the duplicated explanation will be omitted.

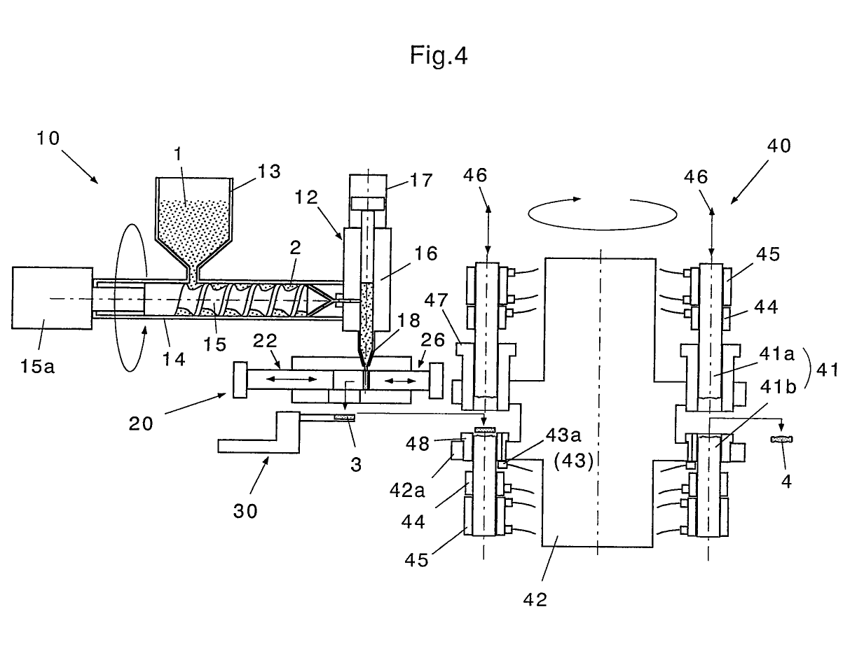

FIG. 4 is an overall block diagram of a micro-molding equipment according to the present invention. As illustrated in this figure, the micro-molding equipment according to the present invention contains a preform molding equipment 10 and a precise compression molding equipment 40.

The preform molding equipment 10 is an apparatus for taking, with a runnerless mold, a single-cavity of a preform material 3 corresponding to a small precision optical component to be molded.

Also, the precision compression molding equipment 40 is an apparatus for performing primary compression molding of a preform material 3 under vacuum, then cooling the preform material to a temperature near a glass transition point, and subsequently re-softening the surface layer for secondary compression molding to transfer the small precision optical component.

The preform mold equipment 10 contains precise quantitation injection equipment 12 and a preform mold equipment 20.

The precise quantitation injection equipment 12 contains a hopper 13 for accommodating a resin 1 for an optical element, a heating cylinder 14 for heating the resin 1, a kneading screw 15 which is driven to rotate by a drive motor 15a and kneads a plasticized melted resin 2, a measuring cylinder 16 for measuring the predetermined amount of melted resin 2 and holding the melted resin 2 therein, and an injection plunger 17 for injecting the melted resin 2 with pressure, and is configured to heat the resin 1 for plasticization, knead the plasticized melted resin 2, and inject the predetermined amount of melted resin 2 from an injection nozzle 18 to the inside of a preform mold equipment 20.

This configuration enables to plasticize and knead the resin sent from the hopper 13 to the kneading screw 15 provided in the heating cylinder 14, and then enables to send by pressure and fill the melted resin in the measuring cylinder 16.

Also, the injection plunger 17 rises along with the resin filled and stops at a predetermined position. This injection plunger 17 enables to inject and fill the melted resin 2 in the preform mold equipment 20 by the injection plunger 17.

The preform mold equipment 20 contains a separable mold 22 which solidifies the ejected melted resin 2 with a runnerless mold and molds the same to the preform material 3, and contains a automatic ejection mechanism 26 capable of automatically ejecting the molded preform material 3.

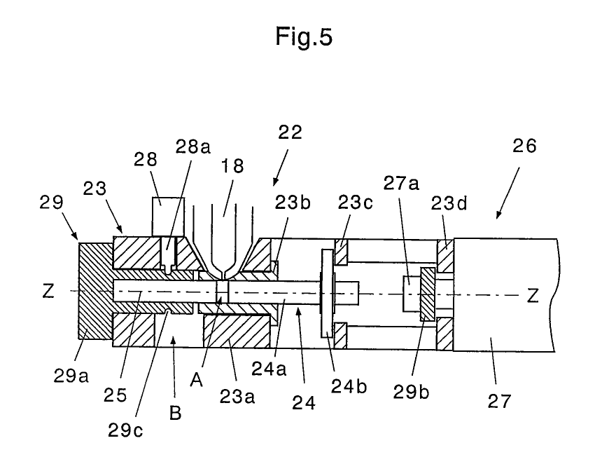

FIG. 5 is a block diagram of the preform mold equipment 20 in FIG. 4.

The separable mold 22 contains a mold body 23, a front core 24, and a rear core 25. The mold body 23 includes mold portions 23a, 23b, and 23c which are integrally connected and secured to fixed positions (not illustrated) so as not to mutually move and has a through hole having a hollow circular cylinder shape in the center of the Z-Z axis in the figure.

The front core 24 contains a cylindrical member 24a to be fitted in the hollow circular cylinder shaped through hole, and a flange member 24b secured near the right end of the cylindrical member 24a, wherein the flange member 24b is configured to be movable in the Z-Z axis direction between the mold portions 23b and 23c.

The rear core 25 is a cylindrical member to be fitted in the hollow circular cylinder shaped through hole, and the left end of which is integrally secured to a connection member 29.

When the front core 24 is moved rightwards to the position in which the flange member 24b comes into contact with the mold portion 23c and the rear core 25 is moved rightwards to the position in which the connection member 29 comes into contact with the mold body 23, relative to the mold body 23, a cavity A equivalent to the preform material corresponding to a small precision optical component to be formed therebetween is formed, as illustrated in FIG. 5.

The cavity A has a cylindrical shape in this example, and the shape and size thereof are set so as to take a single-cavity of a preform material corresponding to a small precision optical component to be formed with a runnerless mold and to prevent great inner deformation due to overpack or the like caused by pressure.

Also, an opening B which is communicated with a space to be formed when the rear core 25 and the rear connecting member 29a for securing the rear core 25 go back leftwards is provided below the mold body 23 so as to drop the preform material downwardly through the opening B.

The automatic ejection mechanism 26 contains a front core working cylinder 27, a rear core lock cylinder 28, and the connection member 29. The front core working cylinder 27 is configured such that a rod 27a thereof may advance and contract in the Z-Z axis direction, and come into contact with the right end surface of the front core 24 to move the same to the left in the figure.

The rear core lock cylinder 28 includes a contractible rod 28a to be fitted in a groove 29c of the connection member 29 to which the rear core 25 is fitted.

The connection member 29 contains the rear connecting member 29a for securing the rear core 25 and a front connecting member 29b secured to the rod 27a of the front core working cylinder 27, wherein these two connecting members 29a and 29b are configured so as to be always synchronized via a connecting bar (not shown) to move in the Z-Z axis direction.

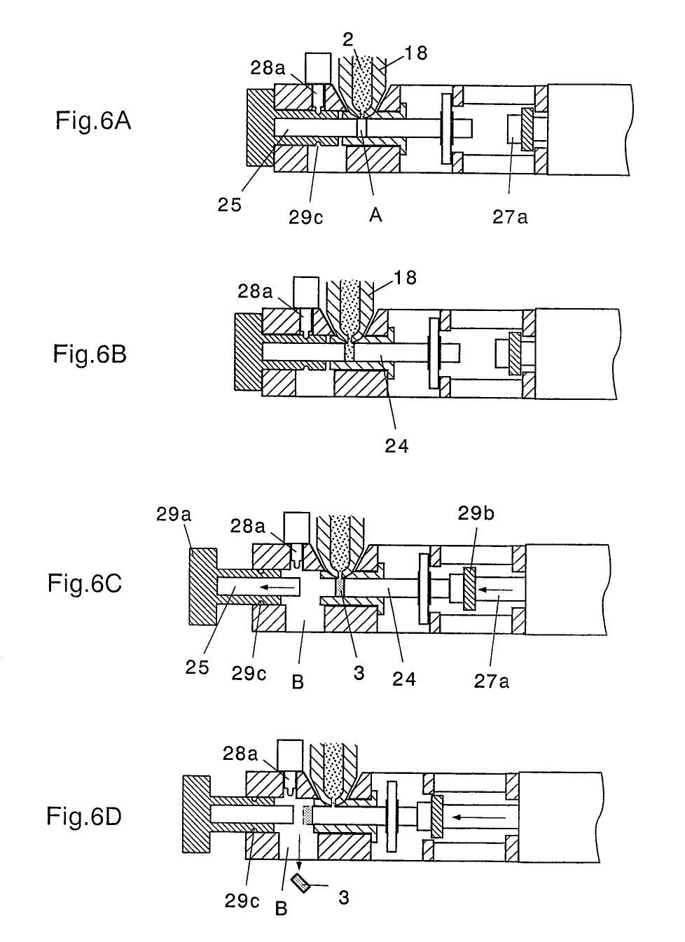

FIGS. 6A through 6D are explanatory diagrams illustrating action of the preform mold equipment in FIG. 4.

In the figures, in a process shown in FIG. 6A, the melted resin 2 is filled in the injection nozzle 18, whereas the cavity A is not yet filled. Also, the rod 28a of the rear core lock cylinder 28 is fitted in the groove 29c so that the rear core 25 may not move.

In a process shown in FIG. 6B, the melted resin 2 is injected and filled in the cavity A, while maintaining the process in FIG. 6A to form a preform material 3 by solidifying the injected resin. In this case, the front core 24 is placed in a position at which the front core 24 contacts the tip of the injection nozzle 18, and runnerless molding may be achieved by moving the tip of the injection nozzle at right angles.

In a process shown in FIG. 6C, the rod 27a is unloosed from the groove 29c, and the rod 27a of the front core working cylinder 27 is extended to the left in the figure and is moved until coming into contact with the right end surface of the front core 24. At the same time, the front connecting member 29b secured to the rod 27a and the rear connecting member 29a move to the left in synchronization with each other and thereby the rear core 25 moves backward to the left. This results in forming a cavity in the left side of the molded preform material 3 with the rear core 25 and the rear connecting member 29a going back to the left.

In a process shown in FIG. 6D, the rod 27a of the front core working cylinder 27 is extended further to the left in the figure, the front core 24 is moved to the left in the figure so that the preform material 3 may project to the left, and the preform material 3 is dropped downward through the opening B to be discharged outside the mold.

After the process illustrated in FIG. 6D, the rod 27a of the front core working cylinder 27 is contracted to the right in the figure and the rod 28a of the rear core lock cylinder 28 is fitted to the groove 29c. The process returns to the process in FIG. 6A.

This configuration enables to take a single-cavity of a preform material 3 corresponding to a small precision optical component to be molded with a runnerless mold by the preform mold equipment 20 and then the mold of the preform mold equipment 20 can be opened so that the preform material 3 can be ejected and dropped onto a transfer equipment 30 by the ejection operation.

In FIG. 4, the transfer equipment 30 is configured so as to receive the preform material 3 dropped from the preform mold equipment 20 on the lower side and insert the received preform material 3 to the predetermined supply position of the precise compression mold equipment 40.

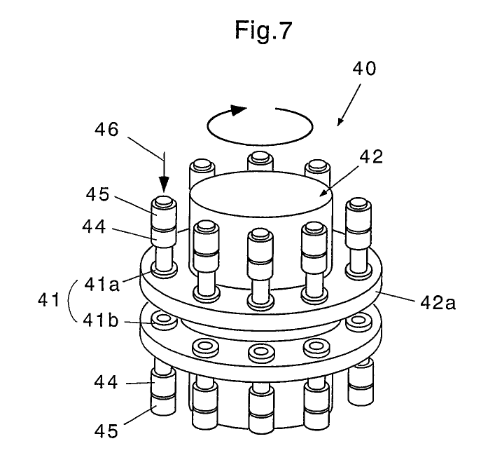

FIG. 7 is an overall perspective view of precise quantitation injection equipment in FIG. 4.

In FIG. 7, since a production tact differs according to sizes of molded components, the number of allocations of fine and precise compression molds is set based on required production amount of molding.

In FIGS. 4 and 7, the precise compression molding equipment 40 includes a plural pairs of precision compression molds 41, a mold index device 42, a vacuum device 43, heating devices 44, cooling devices 45, and compression molding devices 46.

The plural pairs of precision compression molds 41 contain a pair of upper and lower molds 41a and 41b, respectively, and a cavity corresponding to a small precision optical component to be formed therebetween.

The mold index device 42 is a rotary index device in this example, which contains a rotating plate 42a for rotating at a constant angular velocity, and is configured so as to allocate the plural pairs of precision compression molds 41 on the rotating plate 42a and to sequentially move the plural pairs of precision compression molds 41 by a predetermined amount, while rotating. The upper and lower molds 41a and 41b are configured to move vertically along the center of the shaft.

The vacuum device 43 contains a vacuum exhaust outlet 43a communicating with the cavity of the precision compression mold, and a vacuum exhaust device (not illustrated) communicating with the cavity via the vacuum exhaust outlet 43a, and a hollow tube, and is configured so as to evacuate the inside of the cavity formed between the upper and lower molds 41a, 41b to form a vacuum state.

The heating devices 44 are heaters attached to the upper and lower molds 41a, 41b, and are configured to heat the upper and the lower molds 41a, 41b from the outside.

The cooling devices 45 are water-cooling rings attached to the upper and lower molds 41a, 41b, and are configured to cool the precision compression molds to the temperature near the glass transition point.

The compression molding equipment is a pressing device for pressing the upper mold 41a toward the lower mold 41b.

As described above, the precision compression mold 41, the cooling devices 45, the heating devices 44, a movable sleeve 47, a fixed sleeve 48, and the vacuum exhaust outlet 43a are configured in one unit, and a plurality of the units are circularly arranged around the outer circumference of the mold index device 42 (a rotary index compression molding device, in this example).

In this case, the upper mold 41a and the movable sleeve 47 are configured so as to be able to control vertical pressurizing operation, heating, and cooling by an external drive at a required rotational position. Likewise, the vacuum exhaust outlet 43a is also configured to be able to maintain evacuation and the vacuum state at the required rotational position.

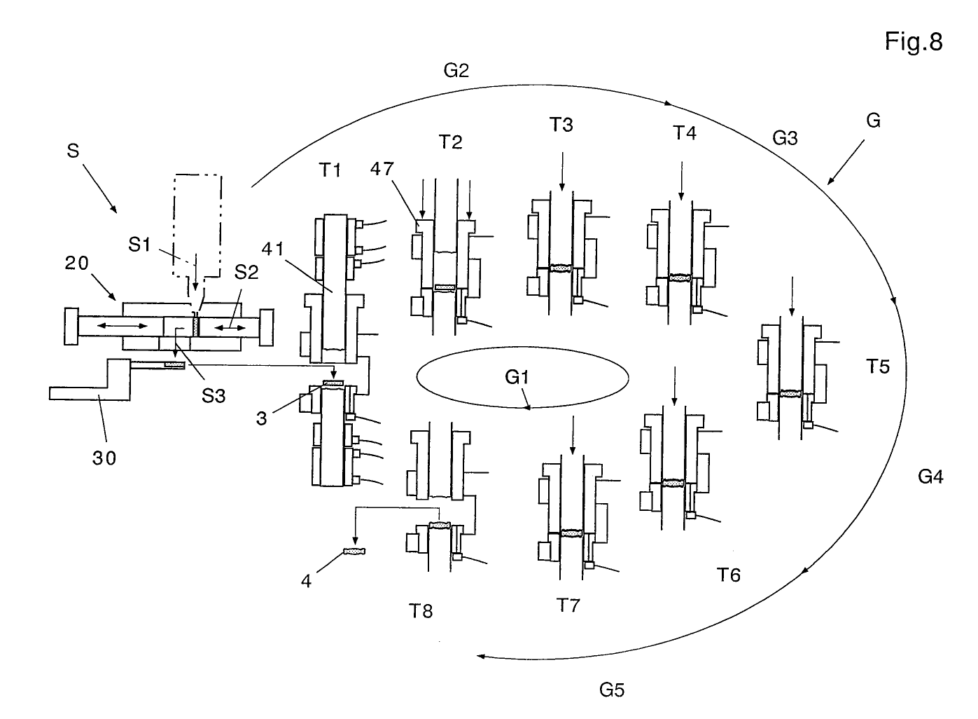

FIG. 8 is an explanatory diagram illustrating action of a micro-molding method according to the present invention.

The micro-molding method according to the present invention contains a preform molding process S and a precise compression molding process G.

The preform molding process S contains a precise quantitation injection process S1 for heating and plasticizing the resin 1, kneading the plasticized melted resin 2, and injecting the predetermined amount of melted resin 2, a preform molding process S2 for solidifying the injected melted resin with a runnerless mold to mold the preform material 3, and a preform ejection process S3 for ejecting the molded preform material 3, and the preform molding process S takes a single-cavity of a preform material 3 corresponding to a small precision optical component to be molded with a runnerless mold.

The preform material 3 dropped from the preform molding equipment 20 is received on the lower side of the transfer equipment 30 and is inserted at the predetermined supply position of the precise compression mold equipment 40.

The precise compression molding process G is a process for cooling the preform material to a temperature near a glass transition point after molding the preform material 3 by means of the primary compression molding in a vacuum state, then re-softening the surface layer for secondary compression molding to transfer the small precision optical component thereto. The molding process G contains a mold index process G1, a vacuum process G2, a primary compression molding process G3, a cooling process G4, and a secondary compression molding process G5.

In the mold index process G1, the plural pairs of precision compression molds 41 including a cavity corresponding to a small precision optical component to be formed by the mold index device 42 are sequentially moved by a predetermined amount. In this example, eight pairs of precision compression molds 41 are sequentially rotated by 45 degrees each at a constant speed or in a form of steps. Each precision compression mold 41 is configured to be sequentially forwarded from a supply position T1 of the preform material 3 to an ejection position T8 in the order of T1, T2, T3, T4, T5, T6, T7, and T8.

In the vacuum process G2, the pressure in the precision compression mold 41 is reduced to a vacuum state. The process is performed between T2 through T7, for instance.

In the primary compression molding process G3, by the heating device 44 to be used in combination with the compression molding equipment 46, the precision compression mold 41 is heated in the vacuum state and the primary compression molding is performed.

Then in the cooling process G4, the precision compression mold 41 is cooled down by the cooling device 45 to the temperature near the glass transition point.

Subsequently, in the secondary compression molding process G5, by the heating device 44 to be used in combination with the compression molding equipment 46, the precision compression mold 41 is reheated and soften the surface of the preform material 3 adhering tightly to the mold by the necessity minimum thickness, and thereby the precise shape is transferred.

In FIG. 8, the preform material 3 molded by the preform molding equipment 20 is transferred to and inserted in the plurality of precision compression molds 41 circularly allocated in the precise compression molding equipment 40 by the transfer equipment 30.

When the precision compression molds 41 are rotary-indexed from T1 to T2, the movable sleeve 47 descends by the external drive and clamps the mold to evacuate the inside of the cavity from the vacuum exhaust outlet 43a.

The heating devices 44 heat and compress the precision compression mold 41 at the position of T3. The precision compression mold 41 is cooled at T4 and is reheated and finely and precisely compressed at T5 and T6. The precision compression mold 41 is cooled at T7, and the movable sleeve 47 and the upper mold 41a are moved upwards at the position of T8, and then the lower mold 41b is moved upwards by the external drive to eject a small precision optical component 4 (fine and precise compression mold).

Generally, when molding a molded component having uneven thickness and thick wall, the resin materials are heated at high temperature to be in a fluid state. In this case, the resin materials are expanded, and gate-sealed after being injected and filled in the cavity. The resin materials then rapidly start solidifying from the surface layer, causing a significant delay in inner solidification. In this case, since the molded component having uneven thickness has uneven contractions equivalent to the uneven thickness as well as overall contractions, it is difficult to finely transfer the shape while maintaining the contraction equal to or below the differential contractions. The same matter occurs in normal compression molding.

On the contrary, the present invention is characterized in that, in molding a molded component having uneven thickness and thick wall requiring fine and precise shape transfer, the preform molding equipment 10 prepares the preform material 3 and the rotary index compression molding equipment (precise compression molding equipment 40) including a plurality of molds for continuously performing compression molding performs fine and precise compression mold.

In the present invention, firstly the preform material 3 is molded with a runnerless mold for the purpose of avoiding waste of resin materials and precisely performing compression molding. Then, the preform material 3 is transferred to the rotary index compression molding equipment containing the plurality of molds by the transfer equipment 30 for the purpose of continuously performing compression molding to be inserted in the cavity, and then the mold is closed to be heated after the vacuum environment is prepared in the cavity. Thus the primary compression molding is performed. Next, after mold cooling is performed temporarily, only a mold core for forming a surface requiring fine and precise transfer is reheated, and only the surface layer closely contacting the core and requiring fine and precise transfer is re-softened.

The surface to be softened in this case has even and thin thickness, and is controlled in which the minimum thickness required for precise transfer is softened. Also, in this case, the inner part of the preform material is in a solid state. The secondary compression molding is performed after the predetermined surface softening is performed, then the mold core is cooled, and the compression mold 4 is ejected.

With the above-described equipment and method according to the present invention, since a single-cavity of preform material corresponding to a small precision optical component to be molded is taken with a runnerless mold, this enables to take a single-cavity of a preform material 3 with a runnerless mold, without generating great inner deformation due to overpack or the like, caused by pressure.

In addition, after primary compression molding of the preform material 3 is performed in a vacuum state, the preform material 3 is temporarily cooled to the temperature near the glass transition point, the surface layer of the preform material 3 is re-softened for secondary compression molding to transfer the small precision optical component 4, and only the surface of the preform material 3 is remolded in the state in which the inner part thereof is solidified. Therefore, this enables to transfer fine and precise shape while avoiding uneven contractions, even when the mold part has uneven thickness and thick wall.

Further, since a single-cavity of the preform material 3 is taken with a runnerless mold and the preform material is molded by means of precise compression molding, this enables to greatly reduce energy loss compared to a case in which a “multiple-cavity” of preform materials are taken or in which the preform material is manufactured in a separate process.

In addition, many of high performance devices or highly-functional devices such as optical devices which require fine and precise compression shapes are manufactured by the injection molding method. In this case, until the products to have dimensional accuracy and optical performances meeting requested specification, it is inevitable many times to repeat experimental production of molds, and tries and errors of molding test. Also, it is impossible to perform fine structural analysis of the high performance devices or highly-functional devices such as optical devices, using commercially available computer simulation soft.

Consequently, it is preferable to use the precision compression molding method as a means for molding an optical device or the like, having a fine and precise shape which cannot be molded in the conventional injection molding method, and perform compression molding simulation analysis of design of the optical device, design and manufacture of molds, and molding conditions thereof by computer analysis, in advance, deleting tries and errors operation from fine compression molding of fine and precise optical component or the like.

It is to be noted that the present invention is not limited to the above-described example and embodiment, and may, of course, be changed in various ways without departing from the gist of the present invention.

1. A micro-molding equipment comprising:
a preform molding equipment for taking a single-cavity of a preform material corresponding to a small precision optical component to be molded with a runnerless mold; and
a precision compression molding equipment which cools the preform material to a temperature near a glass transition point after molding the preform material by primary compression molding in a vacuum state, and then re-softens a surface layer of the preform material and molds the same by secondary compression molding to transfer the small precision optical component thereto.

2. The micro-molding equipment according to claim 1, wherein the preform molding equipment comprises:
a precise quantitation injection equipment for heating and plasticizing a resin, kneading the plasticized melted resin, and injecting a predetermined amount of melted resin; and
a preform molding equipment having a separable mold which solidifies an injected melted resin with a runnerless mold to mold the same into the preform material, and which is capable of automatically ejecting the molded preform material.

3. The micro-molding equipment according to claim 1, wherein:
the precision compression molding equipment comprises:
a plurality of pairs of precision compression molds including cavities corresponding to small precision optical components to be molded;
a mold index device for sequentially moving the plurality of pairs of precision compression molds by a predetermined amount;
a vacuum device for depressurizing insides of the precision compression molds to a vacuum state;
heating devices for heating the precision compression molds;
compression molding devices for performing compression molding by compressing the precision compression molds; and
the cooling devices for cooling the precision compression molds to temperature near a glass transition point, and
the precision compression molding equipment heats the precision compression molds in the vacuum state to perform primary compression molding, and after that reheats the precision compression molds to soften surfaces of the small precision optical components adhering tightly to the molds by the necessity minimum of thickness, and thereby performs secondary compression molding for transferring the fine and precise shapes.

4. A micro-molding method comprising:
a preform molding process for taking a single-cavity of a preform material corresponding to a small precision optical component to be molded with a runnerless mold; and
a precision compression molding process for cooling the preform material to a temperature near a glass transition point after molding the preform material by primary compression molding in a vacuum state, and then re-softening a surface layer of the preform material and molding the same by secondary compression molding to transfer the small precision optical component thereto.

5. The micro-molding method according to claim 4, wherein the preform molding process comprises:
a precise quantitation injection process for heating and plasticizing a resin, kneading the plasticized melted resin, and injecting a predetermined amount of melted resin;
a preform molding process for solidifying the injected melted resin with a runnerless mold to mold the same into the preform material; and
a perform ejection process for ejecting the molded preform material.

6. The micro-molding method according to claim 4, wherein the precision compression molding process comprises:
a mold index process for sequentially moving a plurality of pairs of precision compression molds containing cavities corresponding to small precision optical components to be molded by a predetermined amount;
a vacuum process for depressurizing insides of the precision compression molds to a vacuum state;
a primary compression molding process for performing primary compression molding by heating the precision compression molds in the vacuum state;
a cooling process for cooling the precision compression molds to temperature near a glass transition point; and
a secondary compression molding process for reheating the precision compression molds to soften surfaces of the small precision optical components adhering tightly to the molds by the necessity minimum of thickness and transferring fine and precise shapes thereto.

7. The precision compression molding process method according to claim 6, wherein molding conditions in the precision compression molding process are simulated by numerical analysis in which heat transfer analysis involving shear heating, and compression molding analysis including contact and geometrical nonlinearity analysis are performed in a couple.
